(19) United States
(12) Patent Application Publication
(10) Pub. No.: US 2013/0286087 A1
(43) Pub. Date: Oct. 31, 2013

(54) INKJET INKS WITH POLYURETHANE ADDITIVE WITH A LIMITED AMOUNT OF BRANCHING

(71) Applicant: Charles T. Berge, Earleville, MD (US)

(72) Inventor: Charles T. Berge, Earleville, MD (US)

(73) Assignee: E I DU PONT DE NEMOURS AND COMPANY, Wilmington, DE (US)

(21) Appl. No.: 13/878,248

(22) PCT Filed: Oct. 20, 2011
(86) PCT No.: PCT/US11/57084

§ 371 Date: Apr. 8, 2013

Related U.S. Application Data
(60) Provisional application No. 61/408,030, filed on Oct. 29, 2010.

(51) Int. Cl. C09D 11/00

(52) U.S. Cl. CPC C09D 11/30
USPC 347/20; 524/591; 524/104; 524/84; 568/679

(57) ABSTRACT

Ink for inkjet printing is provided, comprising colorant and certain polyurethane ink additives which are derived from asymmetrically branched polyurethane additives which enhance fastness of the print towards highlighter and finger smudge without compromising jetting performance and storage stability of the ink.

### CROSS-REFERENCE TO RELATED APPLICATION

This application claims priority under 35 U.S.C. §119 from U.S. Provisional Application Ser. No. 61/408,030, filed Oct. 29, 2010.

### FIELD OF THE INVENTION

An inkjet ink is provided, to an aqueous inkjet ink comprising colorants and selected polyurethanes ink additives where the polyurethanes have a limited amount of branching derived from a component which has three isocyanate reactive groups where one or two of the isocyanate reactive groups are amines. The methods of using these polyurethanes in inkjet inks are also provided.

### BACKGROUND OF THE INVENTION

Polyurethanes have been described as ink additives in U.S. Pat. No. 7,176,248 and US20050176848. In U.S. Pat. No. 7,348,368 polyurethanes are described for use as additives to inkjet ink. In US Patent Application No. 20080207811 polyurethanes are described as ink additives and the examples use polymerically dispersed pigments. However, each fails to describe the combination of colorants and the polyurethanes which have branching as a structural component.

It is well known to those of ordinarily skill in the art that thermal inkjet printheads have lower tolerance towards the addition of polymer additives on its jettability and reliability compared to piezo inkjet printheads. While inks based on aqueous dispersions with polyurethane additives have provided improved inkjet inks for many aspects of inkjet printing, a need still exists for improved inkjet ink formulations that provide good print quality and good jettability in particular when used in a thermal inkjet printhead. The present invention satisfies this need by providing compositions having improved optical density, while maintaining other aspects of the ink, dispersion stability, long nozzle life and the like.

### SUMMARY OF THE INVENTION

An embodiment provides the addition of a polyurethane with a limited amount of branching to an aqueous ink comprising a colorant to provide improved fastness of the printed image without compromising color or jetting performance.

A further embodiment provides an aqueous inkjet ink composition comprising:
(a) a colorant;
(b) an aqueous vehicle; and
(c) an asymmetric branched polyurethane ink additive comprising a trisubstituted branching compound which has three isocyanate reactive groups where one or two of them are amines, a first diol, a second diol substituted with an ionic group, and isocyanates
   where the asymmetric trisubstituted branching compound has three isocyanate reactive substituents wherein the first isocyanate reactive substituent is a primary or secondary amine, and the second and third isocyanate reactive substituents are the same or different and are selected from the group consisting of a primary or secondary amine, OH, and SH and where at least one of the second or third isocyanate reactive substituents is OH or SH, and wherein the isocyanate reactive substituents of the asymmetric trisubstituted branching compound is from 0.4 to 30 mole percent of the total isocyanate reactive substituents including the asymmetric trisubstituted branching compound.

The polyurethane which comprises an asymmetrically branched polyurethane ink additive distinct from any polymeric dispersant used for the colorant and can be described as functioning as a binder in the ink.

A further embodiment wherein the inkjet ink may optionally contain other additives and adjuvants well-known to those of ordinary skill in the art.

Within yet another embodiment an aqueous pigmented inkjet ink comprising a colorant and asymmetrically branched polyurethane ink additive described above, having from about 0.05 to about 10 wt % polyurethane ink additive based on the total weight of the ink, having from about 0.1 to about 10 wt % colorant based on the total weight of the ink, a surface tension in the range of about 20 dyne/cm to about 70 dyne/cm at 25° C., and a viscosity of lower than about 30 cP at 25° C.

Yet another embodiment provides the combination of colorant and the selected asymmetric branched polyurethane ink additives to produce inks such that when images are printed, the images have optical densities and/or durability which are improved over the colorants without these asymmetric branched polyurethanes. These improvements enable the success of inkjet inks in making chromatic, high OD images. The selected asymmetric branched polyurethane Ink additives produce stable inks which can be jetted from both piezo and thermal inkjet cartridges.

Another embodiment provides the aqueous ink sets which comprise at least three differently colored inks (such as CMY), and optionally at least four differently colored inks (such as CMYK), wherein at least one of the inks is an aqueous inkjet ink comprising:

(a) a colorant;

(b) an aqueous vehicle; and

(c) an asymmetric branched polyurethane ink additive comprising an asymmetric trisubstituted branching compound which has three isocyanate reactive groups where one or two of the isocyanate reactive groups are amines, diols, diols substituted with an ionic group and isocyanates as set forth above.

When a black ink is included in the CMYK ink set the black ink can be a self-dispersed black pigment.

The other inks of the ink set are also aqueous inks, and may contain dyes, pigments or combinations thereof as the colorant. Such other inks are, in a general sense, well known to those of ordinary skill in the art.

In another aspect, the disclosure provides a method of inkjet printing onto a substrate is provided comprising, in any workable order, the steps of:

(a) providing an inkjet printer that is responsive to digital data signals;

(b) loading the printer with a substrate to be printed;

(c) loading the printer with an aqueous inkjet ink comprising an aqueous ink vehicle, a colorant and asymmetric branched polyurethane ink additive comprising a trisubstituted branching compound, a first diol, a second diol substituted with an ionic group, and isocyanates as described above,

(d) printing onto the substrate using the aqueous inkjet ink, in response to the digital data signals to form a printed image on the substrate.

In yet another aspect, the disclosure provides a method of inkjet printing onto a substrate is provided comprising, in any workable order, the steps of:

(a) providing an inkjet printer that is responsive to digital data signals;

(b) loading the printer with a substrate to be printed;

(c) loading the printer with an inkjet ink set where at least one of the inks in the ink set comprises an aqueous ink vehicle, a colorant and branched polyurethane ink additive comprising an asymmetric trisubstituted branching compound which has three isocyanate reactive groups where one or two of them are amines, a first diol, a second diol substituted with an ionic group, and isocyanates as described above,

(d) printing onto the substrate using the aqueous inkjet ink, in response to the digital data signals to form a printed image on the substrate.

These and other features and advantages of the present invention will be more readily understood by those of ordinary skill in the art from a reading of the following Detailed Description.

Certain features of the invention which are, for clarity, described above and below as separate embodiments, may also be provided in combination in a single embodiment. Conversely, various features of the invention that are described in the context of a single embodiment may also be provided separately or in any subcombination.

### DETAILED DESCRIPTION

Unless otherwise stated or defined, all technical and scientific terms used herein have commonly understood meanings by one of ordinary skill in the art to which this invention pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, reference to enhanced or improved “print quality” means some aspect of optical density of the printed images and fastness (resistance to ink removal from the printed image) is increased, including, for example, rub fastness (finger rub), water fastness (water drop) and smear fastness (highlighter pen stroke).

As used herein, the term “binder” means a film forming ingredient in an inkjet ink.

As used herein, the term “dispersion” means a two phase system where one phase consists of finely divided particles (often in the colloidal size range) distributed throughout a bulk substance, the particles being the dispersed or internal phase and the bulk substance the continuous or external phase.

As used herein, the term “dispersant” means a surface active agent added to a suspending medium to promote uniform and maximum separation of extremely fine solid particles often of colloidal size. For pigments the dispersants are most often polymeric dispersants and usually the dispersants and pigments are combined using dispersing equipment.

As used herein, the term “self-dispersed pigment” means a self-dispersible” or “self-dispersing” pigments.

As used herein, the term “degree of functionalization” refers to the amount of hydrophilic groups present on the surface of the self-dispersed pigment per unit surface area.

As used herein, the term “OD” means optical density.

As used herein, the term “branching” refers to in polymer chemistry a polymer chain having branch points that connect three or more chain segments. As described below the branching herein is limited to three chain segments.

As used herein, the term “asymmetric branching” refers to in polymer chemistry a polymer chain having branch points that connect three or more chain segments where at least one of the branches has a different connective chemistry at the branch.

As used herein, the term “isocyanate reactive substituent” refers to those chemical substituents which react with isocyanate groups; these are commonly —NH_{1,2}, —OH, —SH, and —PH_{1,2}.

As used herein, the term “aqueous vehicle” refers to water or a mixture of water and at least one water-soluble organic solvent (co-solvent).

As used herein, the term “CMY” means the colorants cyan, magenta and yellow used in inks; K or black can be included in the ink description.

As used herein, the term “aromatic” means a cyclic hydrocarbon containing one or more rings typified by benzene which has a 6 carbon ring containing three double bonds.

As used herein, the term “alkyl” means a paraffinic hydrocarbon group which may be derived from an alkane by dropping one hydrogen from the formula and has the generic formula of CₙH₂ₙ₊₁.

As used herein, the term “alkoxy” means an —OR group, where normally the R is an alkyl group or substituted alkyl group.

As used herein, the term “ionizable groups” means potentially ionic groups.

As used herein, the term “AN” means acid number, mg KOH/gram of solid polymer.

As used herein, the term “neutralizing agents” means to embrace all types of agents that are useful for converting ionizable groups to the more hydrophilic ionic (salt) groups.

As used herein, the term “substantially” means being of considerable degree, almost all.

As used herein, the term “Mn” means number average molecular weight.

As used herein, the term “Mw” means weight average molecular weight.

As used herein, the term “Pd” means the polydispersity which is the weight average molecular weight divided by the number average molecular weight.

As used herein, the term “d50” means the particle size at which 50% of the particles are smaller; “d95” means the particle size at which 95% of the particles are smaller.

As used herein, the term “cP” means centipoise, a viscosity unit.

As used herein, the term “prepolymer” means the polymer that is an intermediate in a polymerization process, and can be also be considered a polymer.

As used herein, the term “PUD” means the polyurethanes dispersions described herein.

As used herein, the term “DBTL” means dibutyltin dilaurate.

As used herein, the term “DMPA” means dimethylol propionic acid.

As used herein, the term “EDTA” means ethylenediaminetetraacetic acid.

As used herein, the term “HDI” means 1,6-hexamethylene diisocyanate.

As used herein, the term “GPC” means gel permeation chromatography.

As used herein, the term “IPDI” means isophorone diisocyanate.

As used herein, the term “TMDI” means trimethylhexamethylene diisocyanate.

As used herein, the term “TMXDI” means m-tetramethylene xylylene diisocyanate.

As used herein, the term “ETEGMA//BZMA//MAA” means the block copolymer of ethoxytriethyleneglycol methacrylate, benzylmethacrylate and methacrylic acid.

As used herein the term T650 means TERATHANE® 650.

As used herein, the term “NMP” means n-Methyl pyrrolidone.

As used herein, the term “TEA” means triethylamine.

As used herein, the term “TEOA” means triethanolamine.

As used herein, the term “THF” means tetrahydrofuran.

As used herein, the term “Tetraglyme” means Tetraethylene glycol dimethyl ether.

Unless otherwise noted, the above chemicals were obtained from Aldrich (Milwaukee, Wis.) or other similar suppliers of laboratory chemicals.

TERATHANE 250 and 650 are a 250 and 650 molecular weight, polytetramethylene ether glycols (PTMEG) respectively purchased from Invista, Wichita, Kans.

CERANOL 250 is a 250 molecular weight polyether polyol from DuPont, Wilmington Del.

VORANOL 270 and 230-660 are triol polyether polyols from Dow, Midland Mich.

DENACOL 321 is trimethylolpropane polyglycidyl ether, a cross-linking reagent from Nagase Chemicals Ltd., Osaka, Japan.

The materials, methods, and examples herein are illustrative only and, except as explicitly stated, are not intended to be limiting.

While seeking a balance of new performance parameters needed, ink additives were sought to not only improve the durability but also retain optical density and jettability. Polyurethanes which have as a key structural feature an asymmetric branch point derived from a trisubstituted branching compound which has three isocyanate reactive substituents where the first isocyanate reactive substituent is a primary or secondary amine, and the second and third isocyanate reactive substituents are the same or different and are selected from the group consisting of a primary or secondary amine, OH, and SH and where at least one of the second and third isocyanate reactive substituents are OH or SH. The amount of the trisubstituted asymmetric branching compound in the polyurethane is from 0.4 to 30 mole percent based on all of the isocyanate reactive components. Alternatively, the amount of trisubstituted branching compound can be from 0.6 to 20 mole percent. The asymmetric branched polyurethane improves printed image properties, the durability of the prints and the jettability is improved over other inks with polymer additives. The asymmetry of the branching point is an important feature.

The inks with the asymmetric branched polyurethane additives not only lead to good print properties, but have the requisite properties to perform in all inkjet jetting systems. Normally, when polymeric additives are added to an ink to improve durability, a reduction in the jetting function and other parameters such as, the optical density are observed to degrade. Polyurethanes additives with the asymmetric branching as a key structural feature provide inks with improved durability without loss and/or, while maintaining the optical density and jetting performance.

While not being bound by theory, it is speculated that the asymmetric branching modifies the polyurethane sufficiently to produce these better results. The amount of branching is limited by the amount of the trisubstituted branching compound included in the polyurethane synthesis. If there is too much branching the polyurethane will not improve the ink performance.

As the ink is jetted onto the substrate, often the colorant will penetrate into the substrate as the vehicle absorbs and travels into substrate. With the polyurethane derived from trisubstituted asymmetric branching compound, the colorant may be held more effectively on the substrate surface as the ink dries. Furthermore, this polyurethane/pigment on the top of the substrate apparently incorporates the colorant in a film. This polyurethane/colorant compatibility may lead to less light scatter and good optical density. This polyurethane/colorant may be particularly beneficial when the colorant is a pigment.

The polyurethanes comprise isocyanate compounds and isocyanate reactive compounds. The amount of trisubstituted asymmetric branching compound is described in terms of mole percent of all of the isocyanate reactive compounds. By example, the isocyanate reactive compounds can include the trisubstituted asymmetric branching compound, the first diols, the second diols substituted with an ionic group and any isocyanate reactive compounds used as chain terminators. Thus, in this example the mole percent of the isocyanate reactive groups in the trisubstituted asymmetric branching compound is calculated by dividing the moles of the isocyanate reactive groups of the trisubstituted asymmetric branching compound by the sum of the moles of the isocyanate reactive groups of the trisubstituted branching compound, the first diols, the second diol substituted with an ionic group and the chain terminating compound. The amount is reported as a mole percent.

During the synthesis of the polyurethane the sequence of the reacting components is not critical to obtaining the branched polyurethane. The trisubstituted asymmetric branching compound can be added with the other diols prior to the addition on the diisocyanates. Although not being bound by theory, the reactivity of the amines (as primary and secondary) is sufficiently higher than the —OH and the —SH groups that the branching likely occurs early in the reaction process. During the synthesis it is not necessary to add the trisubstituted branching compound to the diisocyanate prior to addition of the other diols. The addition of the branching compound, the first diol and the second diol can be done in any convenient order.

### Colorants

Suitable colorants for the inks include soluble colorants such as dyes and insoluble colorants such as dispersed pigments (pigment plus dispersing agent) and self-dispersed pigments.

Conventional dyes such as anionic, cationic, amphoteric and non-ionic dyes are suitable. Such dyes are well known to those of ordinary skill in the art. Anionic dyes are those dyes that, in aqueous solution, yield colored anions. Cationic dyes are those dyes that, in aqueous solution, yield colored cations. Typically anionic dyes contain carboxylic or sulfonic acid groups as the ionic moiety. Cationic dyes usually contain quaternary nitrogen groups.

The types of anionic dyes most suitable are, for example, Acid, Direct, Food, Mordant and Reactive dyes. Anionic dyes are selected from the group consisting of nitroso compounds, nitro compounds, azo compounds, stilbene compounds, triarylmethane compounds, xanthene compounds, quinoline compounds, thiazole compounds, azine compounds, oxazine compounds, thiazine compounds, aminoketone compounds, anthraquinone compounds, indigoid compounds and phthalocyanine compounds.

The types of cationic dyes that are most suitable include mainly the basic dyes and some of the mordant dyes that are designed to bind acidic sites on a substrate, such as fibers. Useful types of such dyes include the azo compounds, diphenylmethane compounds, triarylmethanes, xanthene compounds, acridine compounds, quinoline compounds, methine or polymethine compounds, thiazole compounds, indamine or indophenyl compounds, azine compounds, oxazine compounds, and thiazine compounds, among others, all of which are well known to those skilled in the art.

Useful dyes include (cyan) Acid Blue 9 and Direct Blue 199; (magenta) Acid Red 52, Reactive Red 180, Acid Red 37, CI Reactive Red 23; and (yellow) Direct Yellow 86, Direct Yellow 132 and Acid Yellow 23.

Pigments suitable for use are those generally well-known in the art for aqueous inkjet inks. Traditionally, pigments are stabilized by dispersing agents, such as polymeric dispersants or surfactants, to produce a stable dispersion of the pigment in the vehicle. Representative commercial dry pigments are listed in U.S. Pat. No. 5,085,698. Dispersed dyes are also considered pigments as they are insoluble in the aqueous inks used herein. More recently so-called “self-dispersible” or “self-dispersed” pigments (hereafter “SDP”) have been developed. As the name would imply, SDPs are dispersible in water without dispersants.

Pigments which have been stabilized by polymeric dispersants may also have these dispersants crosslinked after the pigments are dispersed. An example of this crosslinking strategy is described in U.S. Pat. No. 6,262,152.

It is generally desirable to make the stabilized pigment in a concentrated form. The stabilized pigment is first prepared by premixing the selected pigment(s) and polymeric dispersant(s) in an aqueous carrier medium (such as water and, optionally, a water-miscible solvent), and then dispersing or deflocculating the pigment. The dispersing step may be accomplished in a 2-roll mill, media mill, a horizontal mini mill, a ball mill, an attritor, or by passing the mixture through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the polymeric dispersant and the pigment under pressure. The media for the media mill is chosen from commonly available media, including zirconia, YTZ and nylon. Preferred are 2-roll mill, media mill, and by passing the mixture through a plurality of nozzles within a liquid jet interaction chamber at a liquid pressure of at least 5,000 psi.

After the milling process is complete the pigment concentrate may be “let down” into an aqueous system. “Let down” refers to the dilution of the concentrate with mixing or dispersing, the intensity of the mixing/dispersing normally being determined by trial and error using routine methodology, and often being dependent on the combination of the polymeric dispersant, solvent and pigment.

A wide variety of organic and inorganic pigments, alone or in combination, may be selected to make the ink. The term “pigment” as used herein means an insoluble colorant. The pigment particles are sufficiently small to permit free flow of the ink through the inkjet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is typically about 0.005 micron to about 15 micron. Preferably, the pigment particle size should range from about 0.005 to about 5 micron and, most preferably, from about 0.005 to about 1 micron. The average particle size as measured by dynamic light scattering is preferably less than about 500 nm, more preferably less than about 300 nm.

The polymerically dispersed pigments may have the polymeric dispersants crosslinked after the dispersion process is completed. In this case the pigment is thought to have its polymeric dispersants crosslinked to each other by the addition of crosslinked components. A type of this crosslinked is described in U.S. Pat. No. 6,262,152.

The selected pigment(s) may be used in dry or wet form. For example, pigments are usually manufactured in aqueous media and the resulting pigment is obtained as water-wet presscake. In presscake form, the pigment is not agglomerated to the extent that it is in dry form. Thus, pigments in water-wet presscake form do not require as much deflocculation in the process of preparing the inks as pigments in dry form.

Self-dispersed pigments (SDPs) can be use with the polyurethanes derived from the branched polyurethanes described above and are often advantageous over traditional dispersant-stabilized pigments from the standpoint of greater optical density and lower viscosity at the same pigment loading. These properties can provide greater formulation latitude in final ink.

Suitable pigment colorants can be self-dispersing pigments. Self-dispersed pigments are surface modified with dispersibility imparting groups to allow stable dispersion without the need for a separate dispersant. For dispersion in an aqueous vehicle, the surface modification involves addition of hydrophilic groups, more specifically, ionizable hydrophilic groups. Methods of making self-dispersed pigments are well known and can be found for example in U.S. Pat. No. 5,554,739 and U.S. Pat. No. 6,852,156.

The self-dispersed pigment colorant can be further characterized according to its ionic character. Anionic self-dispersed pigment yields, in an aqueous medium, particles with anionic surface charge. Conversely, cationic self-dispersed pigment yields, in an aqueous medium, particles with cationic surface charge. Particle surface charge can be imparted, for example, by attaching groups with anionic or cationic moieties to the particle surface. Suitable self-dispersed pigments, although not necessarily, comprise anionic hydrophilic chemical groups.

Anionic moieties attached to the anionic self-dispersed pigment surface can be any suitable anionic moiety but are preferably compounds (A) or (B) as depicted below:

—CO₂Y (A)

—SO₃Y (B)

where Y is selected from the group consisting of conjugate acids of organic bases; alkali metal ions; “onium” ions such as ammonium, phosphonium and sulfonium ions; and substituted “onium” ions such as tetraalkylammonium, tetraalkyl phosphonium and trialkyl sulfonium ions; or any other suitable cationic counterion. Useful anionic moieties also include phosphates and phosphonates. More suitable are type A (“carboxylate”) anionic moieties which are described, for example, in U.S. Pat. No. 5,571,311, U.S. Pat. No. 5,609,671 and U.S. Pat. No. 6,852,156; Alternatively, sulfonated self-dispersed pigments may be used and have been described, for example, in U.S. Pat. No. 5,571,331; U.S. Pat. No. 5,928,419; and EP 146090 A1.

Suitable self-dispersed pigments may be prepared, for example, by grafting a functional group or a molecule containing a functional group onto the surface of the pigment, or by physical treatment (such as vacuum plasma), or by chemical treatment (for example, by oxidatively treating the pigment surface with ozone, hypochlorous acid, sulfonic acid or the like). A single type or a plurality of types of hydrophilic functional groups may be bonded to one pigment particle. The type and degree of functionalization may be properly determined by taking into consideration, for example, dispersion stability in ink, color density, and drying properties at the front end of an inkjet head.

The anionic hydrophilic chemical groups on the self-dispersed pigment can be primarily carbonyl, carboxyl, hydroxyl groups, or a combination of carboxyl, carbonyl and hydroxyl groups; more specifically, the hydrophilic functional groups on the self-dispersed pigment are directly attached and are primarily carboxyl groups, or a combination of carboxyl and hydroxyl.

Pigments having the hydrophilic functional group(s) directly attached may be produced, for example, according to methods disclosed in U.S. Pat. No. 6,852,156. Carbon black treated by the method in U.S. Pat. No. 6,852,156 has a high surface-active hydrogen content which is base neutralized to provide stable dispersions in water. The oxidant is ozone. The carbon black treated by this method is a self-dispersed carbon black pigment. This type of self-dispersed carbon black pigment is commonly used in inkjet inks.

The self-dispersed pigments may have a degree of functionalization wherein the density of anionic groups is less than about 3.5 mmoles per square meter of pigment surface (3.5 mmol/m²), and more specifically, less than about 3.0 mmol/m². Degrees of functionalization of less than about 1.8 mmol/m², and more specifically, less than about 1.5 mmol/m², are also suitable and may be useful for certain specific types of self-dispersed pigments.

### Polyurethane Ink Additives

The polyurethane ink additive is derived from a trisubstituted asymmetric branching compound which has three isocyanate reactive substituents where there is a first isocyanate reactive substituent which is a primary or a secondary amine, and the second and third isocyanate reactive substituents are the same or different and are selected from the group consisting of a primary or secondary amine, —OH, —PH and —SH and where at least one of the second and third isocyanate reactive substituents are —OH or —SH; a first diol; a second diol substituted with an ionic group; and isocyanates

This branching will result at least a portion of the polyurethane being non-linear. The amount of trisubstituted branching compound is from 0.4 to 30 mole percent based on all of the isocyanate reactive groups. At the lower end of this range there will be some of the polyurethanes in the polyurethane which are not branched, but are primarily linear. It is surprising that so little asymmetric branching has such a significant effect on the performance of the polyurethane as an ink additive.

The polyurethane which comprises a trisubstituted asymmetric branching compound which has three isocyanate reactive groups where one or two of them are amines, is a polyurethane ink additive and can be described as functioning as a binder in the ink.

The polyurethane ink additive is in either the form of a water soluble polyurethane or a aqueous polyurethane dispersion. The polyurethane ink additive is distinct from other components added to the ink. The term “polyurethane dispersion” refers to aqueous dispersions of polymers containing urethane groups and optionally urea groups, as that term is understood by those of ordinary skill in the art. These polyurethane polymers also incorporate hydrophilic functionality to the extent required to maintain a stable dispersion of the polymer in water. The second diol containing the ionic group provides the ionic stabilization for the polyurethane dispersion.

### Trisubstituted Branching Compound

The trisubstituted asymmetric branching compound has three isocyanate-reactive substituents where there is a first isocyanate-reactive substituent which is a primary or a secondary amine, and the second and third isocyanate-reactive substituents are the same or different and are selected from the group consisting of a primary or secondary amine, —OH, —PH and —SH and where at least one of the second and third-isocyanate reactive substituents are —OH or —SH.

In general, trisubstituted asymmetric branching compound is an aliphatic compound with the three isocyanate substituents. Non-limiting examples of the trisubstituted asymmetric branching compound include diethanolamine, tris-(hydroxylmethyl)-methylamine, dipropanolamine, 1,5-diamino-3-(2-hydroxy ethyl)pentane, and 2-aminoethane-(2 hydroxy ethyl)amine.

### First Diols

The asymmetric branched polyurethane ink additive includes first diol components. These isocyanate reactive components are chosen for their stability to hydrolysis and other factors.

Examples of polymeric polyols include polyesters, polyethers, polycarbonates, polyacetals, poly(meth)acrylates, polyester amides, and polythioethers. A combination of these polymers can also be used. For examples, a polyether polyol and a poly(meth)acrylate polyol may be used in the same polyurethane synthesis. In the case of using a polyether polyol, both ionic and nonionic stabilization (from the polyether polyol) can contribute to the stabilization of the polyurethane ink additive.

The polycarboxylic acids may be aliphatic, cycloaliphatic, aromatic and/or heterocyclic or mixtures thereof and they may be substituted, for example, by halogen atoms, and/or unsaturated.

Suitable first diols contain at least two hydroxyl groups, and have a molecular weight of from about 60 to about 6000. Of these, the polymeric first diols are best defined by the number average molecular weight, and can range from about 200 to about 6000, specifically, from about 400 to about 3000, and more specifically from about 600 to about 2500. The molecular weights can be determined by hydroxyl group analysis (OH number). An optional first diol includes those that are derived from monomeric 1,n-diols where n is at least 3 and can be up to about 36.

When the first diol is a polyether diol, the polyether diol may be derived from ethylene oxide, propylene oxide and higher oxetanes. The polyether diol has the formula HO [—(CHR)ₐ—O-], where R is hydrogen or alkyl with 1 to 12 carbons; a and b are integers; a is greater than or equal to 2 to 18; and b is greater than or equal to 2 to about 150. Suitable polyether diols have b equal to 3 or 4. Commercially available compounds for when a=3 and b is greater than 3 include CERANOL polyether polyols from DuPont, Wilmington Del. Commercially available compounds for when a=4 and b is greater than 3 include TERATHANE polytetramethylene ether glycols (PTMEG) available from Invista, Wichita, Kans.

Second Diol Substituted with an Ionic Group

The second diol substituted with an ionic group contains ionic and/or ionizable groups. Preferably, these reactants will contain one or two, more preferably two, isocyanate reactive groups, as well as at least one ionic or ionizable group.

Examples of ionic dispersing groups include carboxylate groups (—COOM), phosphate groups (—OPO₃ M₂), phosphonate groups (—PO₃ M₂), sulfonate groups (—SO₃ M), quaternary ammonium groups (—NR₃ Y, wherein Y is a monovalent anion such as chlorine or hydroxyl), or any other effective ionic group. M is a cation such as a monovalent metal ion (e.g., Na⁺, K⁺, Li⁺, etc.), H⁺, NR₄⁺, and each R can be independently an alkyl, aralkyl, aryl, or hydrogen. These ionic dispersing groups are typically located pendant from the polyurethane backbone.

The ionizable groups in general correspond to the ionic groups, except they are in the acid (such as carboxyl —COOH) or base (such as primary, secondary or tertiary amine —NH₂, —NRH, or —NR₂) form. The ionizable groups are such that they are readily converted to their ionic form during the dispersion/polymer preparation process as discussed below.

The ionic or potentially ionic groups are chemically incorporated into the polyurethanes in an amount to provide an ionic group content (with neutralization as needed) sufficient to render the polyurethane dispersible in the aqueous medium of the dispersion. Typical ionic group content will range from about 0.15 up to about 1.8 milliequivalents (meq), optionally, from about 0.36 to about 1.07 meq per 1 g of polyurethane solids.

With respect to compounds which contain isocyanate reactive groups and ionic or potentially ionic groups, the isocyanate reactive groups are typically amino and hydroxyl groups. The potentially ionic groups or their corresponding ionic groups may be cationic or anionic, although the anionic groups are most often used. Examples of anionic groups include carboxylate and sulfonate groups. Examples of cationic groups include quaternary ammonium groups and sulfonium groups.

In the case of anionic group substitution, the groups can be carboxylic acid groups, carboxylate groups, sulphonic acid groups, sulphonate groups, phosphoric acid groups and phosphonate groups. The acid salts are formed by neutralizing the corresponding acid groups either prior to, during or after formation of the NCO pre-polymer, preferably after formation of the NCO pre-polymer.

Preferred carboxylic group-containing compounds are the hydroxy-carboxylic acids corresponding to the structure (HO)ₗQ(COOH)ₖ wherein Q represents a straight or branched, hydrocarbon radical containing 1 to 12 carbon atoms, j is 1 or 2, preferably 2 and k is 1 to 3, preferably 1 or 2 and more preferably 1.

Examples of these hydroxy-carboxylic acids include citric acid, tartaric acid and hydroxypivalic acid. Especially preferred acids are those of the above-mentioned structure wherein j=2 and k=1. These dihydroxy alkanoic acids are described in U.S. Pat. No. 3,412,054, Especially preferred dihydroxy alkanoic acids are the alpha, alpha-dimethylol alkanoic acids represented by the structural formula:

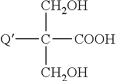

wherein Q′ is hydrogen or an alkyl group containing 1 to 8 carbon atoms. The most commonly used diol compound is alpha, alpha-dimethylol propionic acid, i.e., wherein Q′ is methyl in the above formula.

In order to have a stable dispersion of the branched polyurethane ink additive, a sufficient amount of the ionic groups must be neutralized so that, the resulting polyurethane will remain stably dispersed in the aqueous medium. Generally, at least about 75%, optionally at least about 90%, of the ionic groups are neutralized to the corresponding salt groups.

Suitable neutralizing agents for converting the acid groups to salt groups either before, during, or after their incorporation into the NCO pre-polymers, include tertiary amines, alkali metal cations and ammonia. Preferred trialkyl substituted tertiary amines, such as triethyl amine, tripropyl amine, dimethylcyclohexyl amine, and dimethylethyl amine.

Neutralization may take place at any point in the polyurethane synthesis. A typical procedure includes at least some neutralization of the pre-polymer.

When the ionic stabilizing groups are acids, the acid groups are incorporated in an amount sufficient to provide an acid group content for the urea-terminated polyurethane, known by those skilled in the art as acid number {AN} (mg KOH per gram solid polymer), at least about 10 milligrams KOH per 1.0 gram of polyurethane and optionally 20 milligrams KOH per 1.0 gram of polyurethane. The upper limit for the acid number (AN) is about 100 and optionally about 60.

The branched polyurethanes ink additive has a number average molecular weight of about 4000 to about 30,000 daltons. Optionally, the molecular weight is about 3000 to 20000.

The asymmetric branched polyurethane ink additive is a generally stable aqueous dispersion of polyurethane particles having a solids content of up to about 60% by weight, specifically, about 15 to about 60% by weight and most specifically, about 20 to about 45% by weight. However, it is always possible to dilute the dispersions to any minimum solids content desired.

### Isocyanate Component

Suitable polyisocyanates are those that contain either aromatic, cycloaliphatic or aliphatic groups bound to the isocyanate groups. Mixtures of these compounds may also be used. Preferred are compounds with isocyanates bound to a cycloaliphatic or aliphatic moieties. If aromatic isocyanates are used, cycloaliphatic or aliphatic isocyanates are preferably present as well.

Diisocyanates are suitable, and any diisocyanate useful in preparing polyurethanes and/or polyurethane-ureas from polyether glycols, diisocyanates and diols or amine can be used.

Examples of suitable diisocyanates include, but are not limited to, 2,4-toluene diisocyanate (TDI); 2,6-toluene diisocyanate; trimethyl hexamethylene diisocyanate (TMDI); 4,4′-diphenylmethane diisocyanate (MDI); 4,4′-dicyclohexylmethane diisocyanate (H₁₂MDI); 3,3′-dimethyl-4,4′-biphenyl diisocyanate (TODD; Dodecane diisocyanate (C₁₂DI); m-tetramethylene xylylene diisocyanate (TMXDI); 1,4-benzene diisocyanate; trans-cyclohexane-1,4-diisocyanate; 1,5-naphthalene diisocyanate (NDI); 1,6-hexamethylene diisocyanate (HDI); 4,6-xylyene diisocyanate; isophorone diisocyanate (IPDI); and combinations thereof. IPDI and TMXDI are preferred.

### Preparation of the Branched Polyurethane Ink Additive

The preparation of the branched polyurethane comprises the steps:

(a) providing reactants comprising (i) at least one trisubstituted branching compound, (ii) at least a first diol, (iii) at least one polyisocyanate component comprising a diisocyanate, and (iv) second diol substituted with an ionic group,

(b) reacting (i), (ii), (iii) and (iv) in the presence of a water-miscible organic solvent to form an polyurethane pre-polymer;

(c) adding water to form an aqueous dispersion; and

(d) optionally adding a chain terminated agent before, during or after the addition of the water.

For step (a) the reactants may be added in any convenient order.

The second diol substituted with an ionic group contains ionic or ionizable groups and at the time of addition of water (step (c)), the ionizable groups may be ionized by adding acid or base (depending on the type of ionizable group) in an amount such that the polyurethane can be soluble or stably dispersed. Alternatively, this neutralization can occur at any convenient time during the preparation of the polyurethane.

At some point during the reaction (generally after addition of water and after the optional chain termination), the organic solvent is substantially removed under vacuum to produce an essentially solvent-free dispersion. Alternatively, suitable, non-volatile solvents may be used and left in the polyurethane dispersion.

The ratio of isocyanate to isocyanate reactive groups is from about 1.3:1 to about 1.05:1, and optionally from about 1.25:1 to about 1.10:1. When the moles of isocyanate group exceeds the moles of the isocyanate reactive group the isocyanate terminated polyurethane is often called a polyurethane prepolymer prior to the reaction with chain terminating agent. When the targeted percent isocyanate is reached, then the alcohol, primary amine, or secondary amine chain terminator is added, and then base or acid is added to neutralize ionizable moieties incorporated from the ionizable reagent. When an amine is used as the terminating group the polyurethane is terminated by a urea group. The amount of urea group for these conditions is usually above 1% or more likely above 2%. The urea content of the urea-terminated polyurethane in weight percent of the polyurethane is determined by dividing the mass of amine chain terminator by the sum of the other polyurethane components including the chain terminating agent. The polyurethane solution is then converted to an aqueous polyurethane dispersion via the addition of water under high shear. If present, the volatile solvent can be distilled under reduced pressure or other means. When the isocyanate reactive groups exceed the isocyanate groups the polyurethane can be terminated in alcohol groups.

In some cases, addition of neutralization agent, especially tertiary amines, may be beneficial added during early stages of the polyurethane synthesis. Alternately, advantages may be achieved via the addition of the neutralization agent based on inorganic bases such as an alkali base, simultaneously with the water of inversion at high shear.

It should be understood that the process used to prepare the polyurethane generally results in at least a portion of the branched polyurethane polymer being present in the final product. However, the final product will typically be a mixture of products, of which a portion is the above polyurethane polymer, the other portion being a normal distribution of other polymer products and may contain varying ratios of unreacted monomers. The heterogeneity of the resultant polymer will depend on the reactants selected as well as reactant conditions chosen.

### Ratios of Polyurethane Components

As stated above the ratio of isocyanate to isocyanate reactive groups is from about 1.3:1 to about 1.05:1, and optionally from about 1.25:1 to about 1.10:1. In the case where the isocyanate groups are more than the isocyanate reactive groups, often a chain termination group is used. This chain termination groups can include alcohols and amines.

When the ratio of isocyanate to isocyanate reactive groups is from about 1.30:1 to about 1.05:1 and the terminating agent is a primary or secondary monoamine the amine addition leads to urea termination of the polyurethane.

The amount of chain terminator employed should be approximately equivalent to the unreacted isocyanate groups in the prepolymer. The ratio of active hydrogens from amine in the chain terminator to isocyanate groups in the prepolymer preferably being in the range from about 1.0:1 to about 1.2:1, more preferably from about 1.0:1.1 to about 1.1:1, and still more preferably from about 1.0:1.05 to about 1.1:1, on an equivalent basis.

Aliphatic primary or secondary monoamines are commonly used as chain terminators. Example of monoamines useful as chain terminators include but are not restricted to butylamine, hexylamine, 2-ethylhexyl amine, dodecyl amine, diisopropanol amine, stearyl amine, dibutyl amine, dinonyl amine, bis(2-ethylhexyl)amine, diethyl amine, bis(methoxyethyl)amine, N-methylstearyl amine, diethanolamine and N-methyl aniline.

An optional isocyanate reactive chain terminator is bis(methoxyethyl)amine (BMEA). The bis(methoxyethyl)amine is part of a class of urea terminating reactant where the substituents are non reactive in the isocyanate chemistry, but are nonionic hydrophilic groups. This nonionic hydrophilic group provides the urea termination for the polyurethane with at least some of the polyurethane derived from an asymmetric trisubstituted branching compound and make the polyurethane more water compatible.

### Aqueous Vehicle

Selection of a suitable aqueous vehicle mixture for the inkjet ink formulation depends on requirements of the specific ink jet application, such as desired surface tension and viscosity, the selected colorant, drying time of the ink, and the type of substrate onto which the ink will be printed. Representative examples of water-soluble organic solvents which may be utilized are those that are disclosed in U.S. Pat. No. 5,085,698.

If a mixture of water and an at least one water-miscible solvent is used, the aqueous vehicle typically will contain about 30% to about 95% water with the balance (i.e., about 70% to about 5%) being the water-soluble solvent. Suitable compositions may contain about 60% to about 95% water, based on the total weight of the aqueous vehicle.

The amount of aqueous vehicle in the ink is typically in the range of about 70% to about 99.8%, specifically about 80% to about 99.8%, based on total weight of the ink.

The aqueous vehicle can be made to be fast penetrating (rapid drying) by including surfactants or penetrating agents such as glycol ethers and 1,2-alkanediols. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

### Other Ingredients

Other ingredients may be formulated into the inkjet ink, to the extent that such other ingredients do not interfere with the stability and jettability of the ink, which may be readily determined by routine experimentation. Such other ingredients are in a general sense well known in the art.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), diethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

### Proportion of Main Ingredients

The colorant levels employed in the instant inks are those levels which are typically needed to impart the desired color density to the printed image. Typically, colorant levels are in the range of about 0.05 to about 10% by weight of the ink. The polyurethane ink additive with at least some of the polyurethane having asymmetric branched components added as a distinct additive to the ink at the time the ink is formulated. The various ink components including the polyurethane ink additive can be added together in any convenient order. When the colorant is a pigment there are two dispersions in the ink—the pigment dispersion and the polyurethane dispersion.

The amount of polyurethane ink additive which is used in the inks is dictated by the degree of fixation sought and the range of ink properties which may be tolerated. Typically, polyurethane ink additive levels will range up to about 10 weight %, suitably from about 0.1 to about 8%, more suitably about 0.2 to about 6% by weight of total ink composition. The polyurethane ink additive which has at least some branching provides some degree of improved ink fixation onto the substrate. Better fixation is obtained at higher levels, but generally, at some point, viscosity is increased excessively and jetting performance becomes unacceptable. The right balance of properties must be determined for each circumstance, which determination may generally be made by routine experimentation well within the skill of those of ordinary skill in the art.

### Ink Properties

Jet velocity, separation length of the droplets, drop size and stream stability are greatly affected by the surface tension and the viscosity of the ink. Pigmented inkjet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element, or ejection conditions for a thermal head, for either a drop-on-demand device or a continuous device, and the shape and size of the nozzle. The inks should have excellent storage stability for long periods so as not to clog to a significant extent in an inkjet apparatus. Further, the ink should not corrode parts of the inkjet printing device it comes in contact with, and it should be essentially odorless and non-toxic.

Although not restricted to any particular viscosity range or printhead, the inventive ink set is particularly suited to lower viscosity applications such as those required by thermal printheads. Thus, the viscosity (at 25° C.) of the inventive inks can be less than about 7 cP, is optionally less than about 5 cP, and most advantageously is less than about 3.5 cP. Thermal inkjet actuators rely on instantaneous heating/bubble formation to eject ink drops and this mechanism of drop formation generally requires inks of lower viscosity.

### Substrate

The present invention is particularly advantageous for printing on plain paper, such as common electrophotographic copier paper and photo paper, glossy paper and similar papers used in inkjet printers. Textiles can also be used with these inks.

### EXAMPLES

### Extent of Polyurethane Reaction

The extent of polyurethane reaction was determined by detecting NCO % by dibutylamine titration, a common method in urethane chemistry. In this method, a sample of the NCO containing pre-polymer is reacted with a known amount of dibutylamine solution and the residual amine is back titrated with HCl.

### Particle Size Measurements

The particle size for the polyurethane dispersions, pigments and the inks were determined by dynamic light scattering using a MICROTRAC UPA 150 analyzer from Honeywell/Microtrac (Montgomeryville Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to recover the particle size distribution. Results are reported as D50 and D95.

### Solid Content Measurement

Solid content for the solvent free polyurethane dispersions was measured with a moisture analyzer, model MA50 from Sartorius. For polyurethane dispersions containing high boiling solvent, such as NMP, tetraethylene glycol dimethyl ether, the solid content was then determined by the weight differences before and after baking in 150° C. oven for 180 minutes.

### MW Characterization of the Polyurethane Additive

All molecular weights were determined by GPC using poly(methyl methacrylate) standards with tetrahydrofuran as the eluent. Using statics derived by Flory, the molecular weight of the polyurethane may be calculated or predicted based on the NCO/OH ratio and the molecular weight of the monomers. Molecular weight is also a characteristic of the polyurethane that can be used to define a polyurethane. The molecular weight is routinely reported as number average molecular weight, Mn. The polyurethane additives are not limited to Gaussian distribution of molecular weight, but may have other distributions such as bimodal distributions.

### Asymmetric Branched Polyurethane Ink Additive Example 1

### IPDI/T650/DEA BMEA 45 AN

A 2 liter reactor was loaded with 288.53 g Terathane 650 (OH #172.3, Invista Chemical), 181.95 g tetraglyme, and 0.96 g diethanolamine. While stirring at room temperature 224.14 g isophorone diisocyanate was added over the course of 60 minutes. Temperature was allowed to rise during addition. 61.91 g dimethylol propionic acid was then added to the reactor followed by a 9.58 g rinse of tetraglyme solvent. The reaction was heated to 80° C. and when the solution was clear 0.04 g of dibutyl tin dilaurate was added. When the % NCO was below 1.5%, 24.50 g bis(2-methoxy ethyl)amine was added over 30 minutes followed by a 9.58 g tetraglyme solvent rinse. The reaction was held at 80° C. for 1 hr. The polyurethane solution was inverted under high speed mixing by adding a mixture of 25.87 g KOH in 1684.0 g water. The polyurethane solution had measured solids of 24.99% and a viscosity of 18.7 cPs (30 rpm).

Asymmetric branched polyurethane ink additive Example 2 and 3 and Comparative Ink Additive 1-7 are made in a manner similar to the asymmetric branched polyurethane ink additive example 1, except molar ratios are changed. The changes in molar ratio are shown in Table 1. Comp 1 corresponds to Comparative Ink Additive 1: Comp 2 corresponds to Comparative Ink Additive 2; etc. For the Inventive Examples 1-3 asymmetric branching is obtained with the diethanolamine. For Comparative Examples 1-3 the branching compound is trimethylol propane which has three identical hydroxyl substituents. For Comparative Examples 4-7 the tri hydroxy branching compound is Voranol™ 270 and Voranol™ 230-660 which are alkyl oxide derivatives of glycerin. The mole percent branching is also listed in the table; only the Inventive Examples have the required asymmetric branching.

TABLE 1
Inventive Branched Additives 1-3, Comparative Examples 1-8.

| | | | Branching | | | | | | | |
|---|---|---|---|---|---|---|---|---|---|---|
| | Branching | Mole percent | Monomers. | Terathane ® | | | Tetra- | | | |
| | Monomers, | of trisubsti- | Amt | 650 | DMPA | IPDI | glyme | BMEA | KOH1 | Water |
| | type | tution | moles | moles | moles | moles | grams | moles | moles | grams |
| Inv 1 | DEA | 1.4% | 0.009 | 0.44 | 0.46 | 1.01 | 201 | 0.18 | 0.46 | 1684 |
| Inv 2 | DEA | 7.0% | 0.049 | 0.42 | 0.46 | 1.05 | 339 | 0.19 | 0.46 | 1536 |
| Inv 3 | DEA | 14.8% | 0.066 | 0.23 | 0.28 | 0.67 | 114 | 0.12 | 0.28 | 1011 |
| Comp 1 | TMP | 1.3% | 0.005 | 0.27 | 0.28 | 0.61 | 125 | 0.11 | 0.28 | 1010 |
| Comp 2 | TMP | 7.0% | 0.030 | 0.25 | 0.28 | 0.63 | 124 | 0.11 | 0.28 | 1010 |
| Comp 3 | TMP | 14.7% | 0.065 | 0.23 | 0.28 | 0.67 | 114 | 0.12 | 0.28 | 1011 |
| Comp 4 | Voranol 270 | 1.3% | 0.005 | 0.26 | 0.28 | 0.60 | 125 | 0.11 | 0.28 | 1010 |
| Comp 5 | Voranol 270 | 6.7% | 0.027 | 0.23 | 0.28 | 0.61 | 124 | 0.11 | 0.28 | 1010 |
| Comp 6 | Voranol 270 | 13.3% | 0.055 | 0.19 | 0.29 | 0.63 | 229 | 0.11 | 0.29 | 896 |
| Comp 7 | Voranol 230-660 | | | | | | | | | |
| Comp 8 | NONE | 0.0% | | 0.45 | 0.47 | 1.01 | 202 | 0.18 | 0.46 | 1678 |

### Asymmetric Branched Polyurethane Ink Additive Example 4

### TMXDI/Ceranol™ 250/DEA/DMPA terminated with BMEA; 60 AN

A 2 L reactor was loaded with 92.34 g Ceranol™ 250 (OH #448, DuPont), 108.82 g Sulfolane, 1.20 g diethanolamine, 0.01 g Dibutyl tin dilaurate and 49.25 g dimethylol propionic acid. While stirring at 40° C., 200.85 g TMXDI was added over the course of 60 minutes. A rinse of 5.73 g of sulfolane solvent followed the isocyanate addition The reaction was heated to 50° C. When the % NCO was below 1.28%, 18.57 g bis(2-methoxy ethyl)amine was added over the course of 30 minutes followed by a 73.17 g sulfolane solvent. The reaction was held at 50° C. for 1 hr. The polyurethane solution was inverted under high speed mixing by adding a mixture of 16.52 g KOH in 1010.23 g water. The polyurethane solution had a measured solids of 21.37% and a viscosity of 81.2 cPs (6 rpm) and a GPC molecular weight of 6227 (Mn).

### Asymmetric Branched Polyurethane Ink Additive Example 5

### TMXDI/Terathane® 250/DEA/DMPA Terminated with BMEA; 45 AN

A 2 L reactor was loaded with 92.34 g Terathane® 250 (OH #448.00, Invista Chemical), 108.82 g sulfolane, 1.20 g diethanol amine, 37.16 g dimethylol propionic acid and 0.02 g dibutyl tin dilaurate. Reactor was heated to 80 C, then 134.5 g TMXDI was added over 60 minutes followed by a 5.73 g rinse of sulfolane solvent. Temperature was allowed to rise no higher than 83 C during addition. When the % NCO was below 1.28%, 18.57 g bis(2-methoxy ethyl)amine was added over 30 minutes. The reaction was held at 80° C. for 1 hr. The polyurethane solution was inverted under high speed mixing by adding a mixture of 13.17 g KOH in 1010.23 g water. The polyurethane solution had a measured solids of 22.61% and a viscosity of 130 cPs (3 rpm). The GPC molecular weight was 5974 (Mn).

### Comparative Additive Polymer 8 IPDI/T650 BMEA 45 AN (No Branching Component)

A 2 L reactor was loaded with 192.75 g Terathane 650 (OH #172.3, Invista Chemical), 183.20 g tetraglyme, and 62.38 g dimethylol propionic acid and 0.03 g dibutyl tin dilaurate. The reactor was heated to 80 C, then 223.48 g isophorone diisocyanate was added over the course of 60 minutes followed by a 9.64 g rinse of tetraglyme solvent. Temperature was allowed to rise no higher than 83 C during addition. When the % NCO was below 1.00%, 24.43 g bis(2-methoxy ethyl)amine was added over the course of 30 minutes followed by a 9.5 g tetraglyme solvent rinse. The reaction was held at 80° C. for 1 hr. The polyurethane solution was inverted under high speed mixing by adding a mixture of 26.03 g KOH in 1678.2 g water. The polyurethane solution had a measured solids of 25.2%.

### Dispersant Polymer 1 (Acrylic) ETEGMA//BZMA//MAA 3.6//13.6//10.8

A 3-liter flask was equipped with a mechanical stirrer, thermometer, N₂ inlet, drying tube outlet, and addition funnels. Tetrahydrofuran THF, 291.3 gm, was charged to the flask. The catalyst tetrabutyl ammonium m-chlorobenzoate, 0.44 ml of a 1.0 M solution in acetonitrile, was then added. Initiator, 1,1-bis(trimethylsiloxy)-2-methyl propene, 20.46 gm (0.0882 moles) was injected. Feed I [tetrabutyl ammonium m-chlorobenzoate, 0.33 ml of a 1.0 M solution in acetonitrile and THF, 16.92 gm] was started and added over 185 minutes. Feed II [trimethylsilyl methacrylate, 152.00 gm (0.962 moles)] was started at 0.0 minutes and added over 45 minutes. One hundred and eighty minutes after Feed II was completed (over 99% of the monomers had reacted) Feed III [benzyl methacrylate, 211.63 gm (1.20 moles) was started and added over 30 minutes. Forty minutes after Feed III was completed (over 99% of the monomers had reacted) Feed IV [ethoxytriethyleneglycol methacrylate, 78.9 gm (0.321 moles) was started and added over 30 minutes.

At 400 minutes, 73.0 gm of methanol and 111.0 gm of 2-pyrrolidone was added to the above solution and distillation began. During the first stage of distillation, 352.0 gm of material was removed. Then more 2-pyrrolidone 340.3 gm was added and an additional 81.0 gm of material was distilled out. Finally, 2-pyrrolidone, 86.9 gm total, was added.

The polymer has a composition of ETEGMA//BZMA//MAA 3.6//13.6//10.8. It has a molecular weight of Mn=4,200, acid value 2.90.

### Dispersant Polymer 2 (Acrylic) Diblock 8ETEGMA//30BMA/11MAA

A 3-liter round bottom flask was dried with a heat gun under nitrogen purge and equipped with a mechanical stirrer, thermocouple, N₂ inlet, drying tube outlet, and addition funnels. Tetrahydrofuran (THF), 2423 g, was cannulated to the flask. Initiator (1,1-bis(trimethylsilyloxy)-2-methyl propene, 98.82 g (0.426 moles)) was injected followed by catalyst (tetrabutyl ammonium m-chlorobenzoate, 2.6 ml of a 1.0 M solution in acetonitrile). Catalyst solution (tetrabutyl ammonium m-chlorobenzoate, 2.1 ml of a 1.0 M solution in acetonitrile and THF, 16.1 g) was syringe pumped during both the monomer feeds. Monomer feed 1 (trimethylsilyl methacrylate 728.7 g (4.61 mol) and butyl methacrylate, 1790.9 g (12.61 mol)) was added over 60 minutes while the reaction exothermed to 65° C. After a 1 hr hold, HPLC indicated greater than 95% monomer conversion, and then, monomer feed II (ethyl triethylene glycol methacrylate, 825.3 g (3.35 mol)) was added over 15 minutes.

The ETEGMA conversion was greater than 98% 90 min after the feed was complete. 322.6 g of methanol were added, and then the THF and other volatile by-products were distillated by slowly heating to 120° C. while adding 2-pyrrolidone (2P). The final polymer solution was 45.1% solids with a measured number of 98.2 mg KOH/gram of polymer solids. The molecular weight of this polymer as measured by GPC was Mn 9018, Mw 9635, and PD 1.07.

### Dispersant Polymer 3 (Polyurethane) TMXDI/Terathane® 650/DMPA Terminated with DEA; 60 AN in Sulfolane Solvent

To a dry, alkali- and acid-free flask, equipped with an addition funnel, a condenser, stirrer and a nitrogen gas line was added 135 g Terathane® 650, 54 g DMPA, 132 g Sulfolane and 0.06 g DBTL. The contents were heated to 60° C. and mixed well. 164 g TMXDI was then added to the flask via the addition funnel with any residual TMXDI being rinsed from the addition funnel into the flask with 15 gram sulfolane. The flask temperature was raised to 100° C., held at 100° C. until NCO % was 1.3% or less. Then the reactor temperature was cooled to 60° C. 12.9 g DEA was added over 5 minutes followed by 5 gram sulfolane rinse. After holding for 1 hour at 60° C., 376 g of a 3 wt % aqueous KOH solution was added over 10 minutes via the addition funnel followed by additional 570 g DI water. The mixture was held at 60° C. for 1 hr, then cooled to room temperature. The final polyurethane dispersion had 24% solids.

### Self-Dispersed Black Pigment

The Self-Dispersed Pigment was prepared by methods described in previously referred to U.S. Pat. No. 6,852,156 Example 3.

### Preparation of Inventive Inks 1-3 and Comparative Inks 1-8

Inks were prepared using the branched Polyurethane Ink Additives and Comparative Additive Polymers by combining the components as described below. Percent refers to the active solids. All amounts shown are in weight percent.

The inks were prepared by adding the polymeric dispersed aqueous carbon black pigment dispersion, the free add of branched polyurethane binder and other ink components. The Comparative Ink 8, with a linear polyurethane binder, Comparative Ink Additive 8, was also prepared. The inks are processed by routine operations suitable for ink-jet ink formulation.

All ingredients listed in Table 2, except the carbon black dispersion, were first mixed together. The pigment dispersion was then added slowly, with continuous mixing. The pigment and binder were designed to be 3.0% and 2.0%, respectively, in the final ink.

TABLE 2
Ink Compositions

| Ink Ingredient | Weight % in Ink |
|---|---|
| Butyl Cellosolve | 10.0% |
| Butyl Carbitol | 16.0% |
| 2-Pyrrolidone | 5.0% |
| Polyurethane Binder | 2% |
| Sulfolane | 3% |
| Polymer Dispersed Carbon | 3% |
| Black Aqueous Dispersion. | |
| De-ionized Water | Balance to 100% |

The colorant was a carbon black, Nipex 160 which was dispersed with the Dispersant Polymer 1. The inks made in this fashion were printed on various paper media. The optical density (OD) of the printed pigmented ink with binder was measured, recorded and listed in Table 3. This data can be found in Table 3.

Each ink was filled into an HP88 cartridge and printed using an HP K5400 printer (Hewlett-Packard Co.). The reliability test consisted of repeatedly printing a test image until all the ink in the cartridge was consumed. Typically, this takes about 160 pages. After every ten pages, a nozzle check pattern is printed and the number of nozzles in the print head not firing (missing) is counted. The print head has approximately 1,056 nozzles. The average number of missing nozzles is used as a measure of print reliability.

The optical density was measured using a Greytag-Macbeth SpectoEye™ instrument (Greytag-Macbeth AG, Regensdorf, Switzerland).

The durability of the image towards highlighter smear was done using a Faber-Castel highlighter pen after the printed image was allowed to dry for about an hour after printing. The image was marked once and twice with the highlighter. The amount of ink transfer into the unprinted area by the highlighter pen was noted by visual inspection and rated on a scale of 1 to 5 with 5 being best. The 5 rating has little if any smearing of the printed image with the highlighter.

Print data is reported in Table 3 are average of multiple measurements. For optical density and durability, the average was measured on three paper types: Hammermill™ Copy Plus (HCP), HP Multipurpose with ColorLok® (HPMP) and Xerox™ 4200 (4200). In all cases, higher values indicate higher level and better performance.

TABLE 3
Inventive Branched Additives 1-3, Comparative
Examples 1-8; print results.

| | HP Bright | HP Multi- | Xerox | | |
|---|---|---|---|---|---|
| | White | purpose | 4200 | Nozzle | |
| | Optical Density | | | Outs | Smudge |
| inv 1 | 1.39 | 1.38 | 0.87 | 3 | 4 |
| inv 2 | 1.38 | 1.37 | 0.86 | 62 | 3 |
| inv 3 | 1.40 | 1.40 | 0.86 | 14 | 2 |
| Comp 1 | 1.34 | 1.38 | 0.85 | 5 | 2 |
| Comp 2 | 1.32 | 1.34 | 0.85 | 65 | 2 |
| Comp 3 | 1.28 | 1.24 | 0.83 | 143 | 3 |
| Comp 4 | 1.36 | 1.37 | 0.85 | 13 | 2 |
| Comp 5 | 1.37 | 1.35 | 0.86 | 19 | 2 |
| Comp 6 | 1.35 | 1.36 | 0.86 | 42 | 2 |
| Comp 7 | 1.29 | 1.31 | 0.86 | 70 | 2 |
| Comp 8 | 1.37 | 1.38 | 0.86 | N/A | N/A |

The inventive inks are comparable or better in optical density, better for smudge and substantially better for nozzle outs, a measure of print reliability for an ink.

### Preparation of Inventive Ink 4

Inventive Ink Example 4 demonstrates the use of branched urethane binder in an ink using a pigment which is dispersed with a polyurethane dispersant (Dispersant 3) and crosslinked to enhance stability and performance of the dispersion. Then an ink is produced using this dispersion and PU4, a branched polyurethane ink additive. Finally, the ink is successfully printed on to paper.

The following procedure was used to prepare the pigment dispersions with polyurethane dispersing resin. Using an Eiger Minimill, the targeted dispersant level was selected at a P/D (pigment/dispersant) ratio of 2.5. A P/D of 2.5 corresponds to a 40% dispersant level on pigment. A co-solvent was added at 10% of the total dispersion formulation to facilitate pigment wetting and dissolution of the resins in premix stage and ease of grinding during milling stage. Although other similar co-solvents are suitable, triethylene glycol monobutyl ether (TEB as supplied from Dow Chemical) was the co-solvent of choice. The dispersant 3 was pre-neutralized with KOH to facilitate solubility and dissolution into water. During the premix stage the pigment level was maintained at approximately 27% and was subsequently reduced to about 24% during the milling stage by adding deionized water for optimal media mill grinding conditions. After completion of the milling stage, 4 hours, the remaining letdown of de-ionized water was added and thoroughly mixed.

All the pigmented dispersions processed with co-solvent were purified using an ultrafiltration process to remove co-solvent(s) and filter out other impurities and ions that may be present. After completion, the pigment level in the dispersions was reduced to about 10%.

| | | Polyurethane | | |
|---|---|---|---|---|
| Pigment | Pigment/ | Dispersant, | Particle Size | |
| Dispersion | Dispersant | wt percent | D50 (nm) | D95 (nm) |
| C1 | 2.5 | 3 | 90 | 203 |

In the cross-linking step, the cross-linking agent, Denacol® 321, was mixed with the above pigment dispersions, and heated to 80° C., with efficient stirring, for 8 hours. At the completion of the cross-linking reaction (8 hours) the pH was adjusted to 8.0 with a 45% KOH aqueous solution. Table 4 summarized the cross-linking recipe for the Carbon Black Pigment Dispersion (C1) crosslinking.

TABLE 4

| | | | | Crosslinker |
|---|---|---|---|---|
| Crosslinked | | Crosslinking | Crosslinking | to COOH |
| Dispersion | Dispersion | moiety | Compound | Mole ratio |
| XL-C1 | C1 | COOH, OH | Denacol 321 | 1:4 |

### Preparation and Printing of Crosslinked Carbon Black (XL-C1) Ink with Asymmetric Branched Polyurethane Additive 4

The ink was prepared by conventional processes known to one skilled in the art using the cross-linked Dispersion XL-C1 and asymmetric branched polyurethane additive 4. The ink is processed by routine operations suitable for ink-jet ink formulation. Inventive Ink 4 was prepared as follows. All ingredients listed in Table 4, except the crossed-linked pigment dispersion (XL-C1), were first mixed together. The asymmetric branched polyurethane additive 4 was added to achieve 2.0 weight % polyurethane resin in final ink. After ingredients have been thoroughly mixed, the XL-C1 dispersion was added in an amount that gave 3.0 weight % pigment in the final ink. A Comparative Ink 9 was prepared with the same formulation except no branched polyurethane ink additive was included.

TABLE 5
Ink Composition

| Ink Ingredient | Weight % in Ink |
|---|---|
| Butyl Cellosolve | 10.0% |
| Butyl Carbitol | 16.0% |
| 2-Pyrrolidone | 5.0% |
| PU12 binder | 2.0% |
| Sulfolane | 3.0% |
| Cross-linked Dispersion XL-C1 | 3.0% |
| De-ionized Water | Balance to 100% |

As shown in Table 6, the ink made with Cross-Linked Carbon Black Dispersion, XL-C1, together with the asymmetric branched polyurethane additive 4, in general shows lower optical density, yet better smudge and highlighter smear properties than the comparative ink without binder.

TABLE 6

| | Paper Media | | | | | | | |
|---|---|---|---|---|---|---|---|---|
| | HP Bright White | | HP Multipurpose | | Xerox 4200 | | HP Brochure | |
| | w/binder | No binder | w/binder | No binder | w/binder | No binder | w/binder | No binder |
| Print Performance | | | | | | | | |
| OD | 1.33 | 1.41 | 1.27 | 134 | 0.84 | 0.84 | 1.57 | 164 |
| Print Durability on Media | | | | | | | | |
| Smudge | 2 | 2 | 3 | 2 | 4 | 4 | 3 | 2 |
| Highlighter Smear 10 min (1X) | 4 | 4 | 4 | 4 | 5 | 5 | 4 | 1 |
| Highlighter Smear 1 hr.(1X) | 4 | 4 | 4 | 4 | 5 | 5 | 5 | 2 |
| Highlighter Smear 10 min (2X) | 1 | 1 | 1 | 1 | 4 | 4 | 2 | 1 |
| Highlighter Smear 1 hr.(2X) | 2 | 1 | 1 | 1 | 4 | 4 | 4 | 1 |

Inventive Ink 4 is listed as w/binder and Comparative Ink 9 is listed as no binder.
Visual Rating for Smudge
0 - Ink largely removed
2 - Severe smudge
3 - Moderate smudge
4 - Very slight smudge
5 - No smudge visible
Visual Rating for Highlighter Smear
0 - Ink largely removed from stripe with highlighter
1 - Severe smear, considerable color transfer, may be some damage to stripe
2 - Noticeable smear, run full width of area between stripes
3 - Moderate smear, may be full width of highlighter, but light in color
4 - Slight smear, narrow, doesn't run clear to next stripe
5 - No smear visible

### Preparation of Inventive Ink 5

### Example of an Inkjet Ink Using a Black Self-Dispersed Pigment as Colorant and a Asymmetric Branched Polyurethane Additive 1 for Print Durability.

A branched urethane binder was formulated with a Self-Dispersing Pigment (SDP) to improve durability. The carbon black SDP prepared as describe above. Asymmetric branched polyurethane polymer additive 1 was utilized as the binder in this ink. The ink formulation was prepared by the same process as in Table 4 with the above described colorant and binder. The ink was printed on various paper media and the print was accessed for Optical Density (OD) and smudge durability. The results are tabulated in Table 7.

TABLE 7
Optical Density and Smudge Durability on Various Paper Media

| | Hammermill | | HP Brochure | | HP Multipurpose | | Xerox 4200 | |
|---|---|---|---|---|---|---|---|---|
| OD | 1.12 | 1.27 | 1.72 | 1.81 | 1.36 | 1.38 | 1.13 | 1.30 |

1. An aqueous inkjet ink composition comprising:
(a) a colorant;
(b) an aqueous vehicle; and
(c) an asymmetric branched polyurethane additive comprising a trisubstituted branching compound, a first diol, a second diol substituted with an ionic group, and isocyanates where the trisubstituted branching compound has three isocyanate reactive substituents wherein the first isocyanate reactive substituent is a primary or secondary amine, and the second and third isocyanate reactive substituents are the same or different and are selected from the group consisting of a primary or secondary amine, OH, and SH and where at least one of the second and third isocyanate reactive substituents are OH or SH, and wherein the isocyanate reactive substituents of the trisubstituted branching compound is from 0.4 to 30 mole percent of the total isocyanate reactive substituents including the trisubstituted branching compound.

2. The aqueous inkjet ink composition of claim 1, wherein the asymmetric branched polyurethane ink additive is from 0.05 to 10%, by weight based on the weight of the total ink composition.

3. The aqueous inkjet ink composition of claim 1, wherein the asymmetric branched polyurethane ink additive is from 0.2 to 7% by weight based on the weight of the total ink composition.

4. The aqueous inkjet ink composition of claim 1, having from 0.1 to 10 wt % colorant based on the total weight of the ink, a surface tension in the range of 20 dyne/cm to 70 dyne/cm at 25° C., and a viscosity of lower than 30 cP at 25° C.

5. The aqueous inkjet ink composition of claim 1, wherein the asymmetric branched polyurethane ink additive has an acid number (mg KOH per gram solid polymer) of at least 10 and at most 100.

6. The aqueous inkjet ink composition of claim 1, wherein the asymmetric branched polyurethane ink additive has an number average molecular weight of 4,000 to 30,000 daltons.

7. The asymmetric branched polyurethane ink additive of claim 1 where the first diol is a polyether diol.

8. The polyether diol of claim 7 where the polyether diol has the formula HO [—(CHR)ₐ—O—]_{b}
wherein R is hydrogen or alkyl with 1-12 carbons;
a and b are integers;
a is greater than or equal to 2 to 18; and
b is greater than or equal to 2 to about 150.

9. The polyether diol of claim 8 where a is 3 or 4.

10. An aqueous inkjet ink composition of claim 1, wherein the colorant is a selected from pigments or dispersed dyes.

11. An aqueous inkjet ink composition of claim 10, wherein the colorant is a self-dispersed pigment.

12. The self-dispersed pigment of claim 11, wherein the self-dispersed pigment further comprises anionic hydrophilic chemical groups.

13. The self-dispersed pigment of claim 12, wherein the anionic hydrophilic chemical groups are carboxyl groups.

14. The self-dispersed pigment of claim 11, 12 or 13, wherein the self-dispersed pigment comprises a pigment that has been oxidatively treated on its surface with hypochlorous acid, sulfonic acid, or ozone so as to bond at least one functional group selected from the group consisting of carbonyl, carboxyl, hydroxyl and sulfone, onto the surface of the pigment.

15. The self-dispersed pigment of claim 14, wherein the self-dispersed pigment comprises a pigment that has been oxidatively treated on its surface with ozone.

16. The aqueous inkjet ink composition of claim 1, wherein the aqueous vehicle is a mixture of water and at least one water-miscible solvent.

17. A method of inkjet printing onto a substrate is provided comprising, in any workable order, the steps of:
(a) providing an inkjet printer that is responsive to digital data signals;
(b) loading the printer with a substrate to be printed;
(c) loading the printer with an aqueous inkjet ink composition comprising:
(i) a colorant;
(ii) an aqueous vehicle; and
(iii) an asymmetric branched polyurethane additive comprising a trisubstituted branching compound, a first diol, a second diol substituted with an ionic group, and isocyanates where the trisubstituted branching compound has three isocyanate reactive substituents wherein the first isocyanate reactive substituent is a primary or secondary amine, and the second and third isocyanate reactive substituents are the same or different and are selected from the group consisting primary or secondary amine, OH, and SH and where at least one of the second and third isocyanate reactive substituents are OH or SH, and wherein the isocyanate reactive substituents of the trisubstituted branching compound is from 0.4 to 30 mole percent of the total isocyanate reactive substituents including the trisubstituted branching compound;
(d) printing onto the substrate using the aqueous inkjet ink, in response to the digital data signals to form a printed image on the substrate.

18. An inkjet ink set wherein at least one of the inks in the inkjet ink set is an aqueous inkjet ink composition comprising
(a) a colorant;
(b) an aqueous vehicle; and
(c) an asymmetric branched polyurethane ink additive comprising: a trisubstituted branching compound, a first diol, a second diol substituted with an ionic group, and isocyanates where the trisubstituted branching compound has three isocyanate reactive substituents wherein the first isocyanate reactive substituent is a primary or secondary amine, and the second and third isocyanate reactive substituents are the same or different and are selected from the group consisting of a primary or secondary amine, OH, and SH and where at leash one of the second and third isocyanate reactive substituents are OH or SH, and wherein the isocyanate reactive substituents of the trisubstituted branching compound is from 0.4 to 30 mole percent of the total isocyanate reactive substituents including the trisubstituted branching compound.

19. The method of inkjet printing onto a substrate of claim 17, wherein
the aqueous inkjet ink composition is part of an aqueous inkjet ink set.
